(19) United States
(12) Patent Application Publication
(10) Pub. No.: US 2024/0410979 A1
(43) Pub. Date: Dec. 12, 2024

(54) RADAR SYSTEM AND DATA PROCESSING METHOD FOR RADAR SYSTEM

(71) Applicant: TRON FUTURE TECH INC., HSINCHU CITY (TW)

(72) Inventors: YEN-MING HUANG, HSINCHU CITY (TW); CHENG-YUNG KE, HSINCHU CITY (TW); PAO MING LU, HSINCHU CITY (TW); BOR-CHING SU, HSINCHU CITY (TW); YU-JIU WANG, HSINCHU CITY (TW)

(21) Appl. No.: 18/607,095

(22) Filed: Mar. 15, 2024

Related U.S. Application Data
(60) Provisional application No. 63/490,765, filed on Mar. 16, 2023.

(51) Int. Cl. G01S 7/41; G01S 7/292; G01S 13/02; G01S 13/58; G01S 13/72

(52) U.S. Cl. CPC G01S 7/415; G01S 7/292; G01S 13/582; G01S 13/72; G01S 2013/0254

(57) ABSTRACT

A radar system includes a first subarray, a second subarray and a third subarray. The first subarray includes a plurality of first antennas arranged along a first direction. The second subarray includes a plurality of second antennas arranged along the first direction. The third subarray includes a plurality of third antennas arranged along a second direction orthogonal to the first direction. The third subarray is configured to combine a first set of data received from the first subarray and a second set of data received from the second subarray into a combined set of data, generate first beamformed data indicating target azimuth information by applying beamforming to the combined set of data, and generate second beamformed data indicating target elevation information according to a plurality of input signals received by the third antennas.

### PRIORITY CLAIM AND CROSS-REFERENCE

The present application claims priority to U.S. Provisional Patent Applications including Ser. No. 63/490,765, filed on Mar. 16, 2023, which is incorporated by reference herein in its entirety.

### BACKGROUND

The present disclosure relates to a radar system and, more particularly, to an active electronically scanned array (AESA) radar system and a data processing method for a radar system.

Radar technology comes in various types and configurations, and finds use in many applications. For example, a phased array radar, also known as an active electronically scanned array (AESA) radar, can employ an array of antennas that electronically steers a radar beam without moving antennas and pedestals. The phased array radar can be used for air traffic control, military surveillance, and missile defense. However, the phased array radar typically adopts the fully populated planar array configuration, which necessitates numerous antenna elements and complex signal processing. Due to the drawbacks associated with its large size, high power consumption and high manufacturing cost, the phased array radar faces challenges in entering the commercial markets and civilian applications. Thus, there is a need in the art for an improved design to enable accurate and cost-effective surveillance of various types of targets.

### SUMMARY

The described embodiments provide to an active electronically scanned array (AESA) radar system and a data processing method for a radar system.

Some embodiments described herein may include a radar system. The radar system includes a first subarray, a second subarray and a third subarray. The first subarray includes a plurality of first antennas arranged along a first direction. The second subarray includes a plurality of second antennas arranged along the first direction. The third subarray includes a plurality of third antennas arranged along a second direction orthogonal to the first direction. The third subarray is configured to combine a first set of data received from the first subarray and a second set of data received from the second subarray into a combined set of data, generate first beamformed data indicating target azimuth information by applying beamforming to the combined set of data, and generate second beamformed data indicating target elevation information according to a plurality of input signals received by the third antennas.

Some embodiments described herein may include a radar system. The radar system includes a first subarray, a second subarray and a third subarray. The first subarray includes a plurality of first antennas and a first signal processing circuit. The first antennas are arranged along a first direction. The first signal processing circuit, coupled to the first antennas, is configured to process a plurality of first electrical signals received from the first antennas to generate a first set of data. The second subarray includes a plurality of second antennas and a second signal processing circuit. The second antennas are arranged along the first direction. The second signal processing circuit, coupled to the second antennas, is configured to process a plurality of second electrical signals received from the second antennas to generate a second set of data. The third subarray includes a plurality of third antennas and a third signal processing circuit. The third antennas are arranged along a second direction orthogonal to the first direction. The third signal processing circuit is coupled to the first signal processing circuit, the second signal processing circuit and the third antennas. The third signal processing circuit is configured to generate first beamformed data indicating target azimuth information according to the first set of data and the second set of data.

Some embodiments described herein may include a data processing method for a radar system. The data processing method includes: generating a first set of data according to a plurality of first electrical signals received from a plurality of first antennas of the radar system, wherein the first antennas are arranged along a first direction, and the first set of data is structured as a first datacube; generating a second set of data according to a plurality of second electrical signals received from a plurality of second antennas of the radar system, wherein the second antennas are arranged along the first direction, the second set of data is structured as a second datacube, and each of the first datacube and the second datacube is represented in a range domain, a velocity domain and an angular domain; stacking the first datacube and the second datacube in the angular domain to form a composite datacube; and applying beamforming to the composite datacube to generate first beamformed data indicating target azimuth information.

The proposed radar system can utilize a two-dimensional sparse orthogonal linear phased array to perform target detection and positioning in a three-dimensional space, thereby significantly reducing manufacturing costs and effectively detecting targets with small radar cross-sections, low flying speeds and altitudes, and/or arbitrary trajectories. In addition, the proposed radar signal and data processing scheme not only can reduce the complexity of signal processing and the amount of transmitted data, but also can generate highly accurate target information.

### BRIEF DESCRIPTION OF THE DRAWINGS

Aspects of the present disclosure are best understood from the following detailed description when read with the accompanying figures. It is noted that, in accordance with the standard practice in the industry, various features are not drawn to scale. In fact, the dimensions of the various features may be arbitrarily increased or reduced for clarity of discussion.

FIG. 1 is a diagram illustrating an exemplary radar system in accordance with some embodiments of the present disclosure.

FIG. 2 is a block diagram of the radar system shown in FIG. 1 in accordance with some embodiments of the present disclosure.

FIG. 3 is an implementation of the radar system shown in FIG. 2 in accordance with some embodiments of the present disclosure.

FIG. 4 is a top view of the radar system shown in FIG. 1 configured for target detection in accordance with some embodiments of the present disclosure.

FIG. 5 is a timing diagram of the transceiver architecture shown in FIG. 3 in one coherent processing interval in accordance with some embodiments of the present disclosure.

FIG. 6 illustrates an implementation of the digital transmitter assembly and the digital receiver assembly shown in FIG. 1 in accordance with some embodiments of the present disclosure.

FIG. 7 is a diagram illustrating the datacube format processed by the digital receiver assembly shown in FIG. 6 in accordance with some embodiments of the present disclosure.

FIG. 8 is a diagram illustrating a range-velocity plane outputted by the horizontal/vertical beamforming module shown in FIG. 6 in accordance with some embodiments of the present disclosure.

FIG. 9A is a diagram illustrating operation of the radar system shown in FIG. 1 in a scanning mode in accordance with some embodiments of the present disclosure.

FIG. 9B is a diagram illustrating operation of the radar system shown in FIG. 1 in another scanning mode in accordance with some embodiments of the present disclosure.

FIG. 10 is a flow chart of a data processing method for a radar system in accordance with some embodiments of the present disclosure.

### DETAILED DESCRIPTION

The following disclosure provides many different embodiments, or examples, for implementing different features of the provided subject matter. Specific examples of components and arrangements are described below to simplify the present disclosure. These are, of course, merely examples and are not intended to be limiting. For example, the present disclosure may repeat reference numerals and/or letters in the various examples. This repetition is for the purpose of simplicity and clarity and does not in itself dictate a relationship between the various embodiments and/or configurations discussed.

Further, it will be understood that when an element is referred to as being “connected to” or “coupled to” another element, it may be directly connected to or coupled to the other element, or intervening elements may be present.

In recent years, affordability and portability of drones have led to their widespread adoption in various civilian applications such as aerial photography, reconnaissance survey, and remote inspection. However, the misuse of drones also poses threats to personal security, important facilities, and national infrastructures. Establishing anti-drone systems to detect, track, and take countermeasures against hostile drone targets has become increasingly important. One approach is to utilize active electronically scanned array (AESA) radar systems to implement drone surveillance radars. However, the AESA radar systems are usually unwieldy and mostly used for military applications such as missile tracking, making them unsuitable for detecting drones, especially micro-flying drones used for civilian purposes. These micro-flying drones possess characteristics such as smaller radar cross sections (RCSs), low flying speeds and altitudes, and arbitrary trajectories, which differ significantly from the behavior of missiles, fighter jets, and warships.

The present disclosure provides exemplary radar systems, each of which employs a two-dimensional (2D) sparse orthogonal linear phased array to facilitate target detection and positioning in three-dimensional (3D) space. Compared to radar systems using fully-populated planar arrays, the proposed radar systems not only significantly reduce costs but also effectively detect, track, and identify targets with smaller RCSs, low flying speeds and altitudes, and/or arbitrary trajectories.

Furthermore, in the proposed radar systems, different subarrays arranged along a first direction (e.g. a horizontal direction) can process respective received target signals, and the processed target signals can converge to a signal processing circuit of a subarray that is arranged along a second direction orthogonal to the first direction (e.g. a vertical direction). The signal processing circuit of the subarray arranged along the second direction can perform beamforming not only upon signals received from antennas arranged along the second direction but also upon signals received from the subarrays arranged along the first direction, thereby reducing the complexity of signal processing and the amount of transmitted data, and generating highly accurate target information. Further description is provided below.

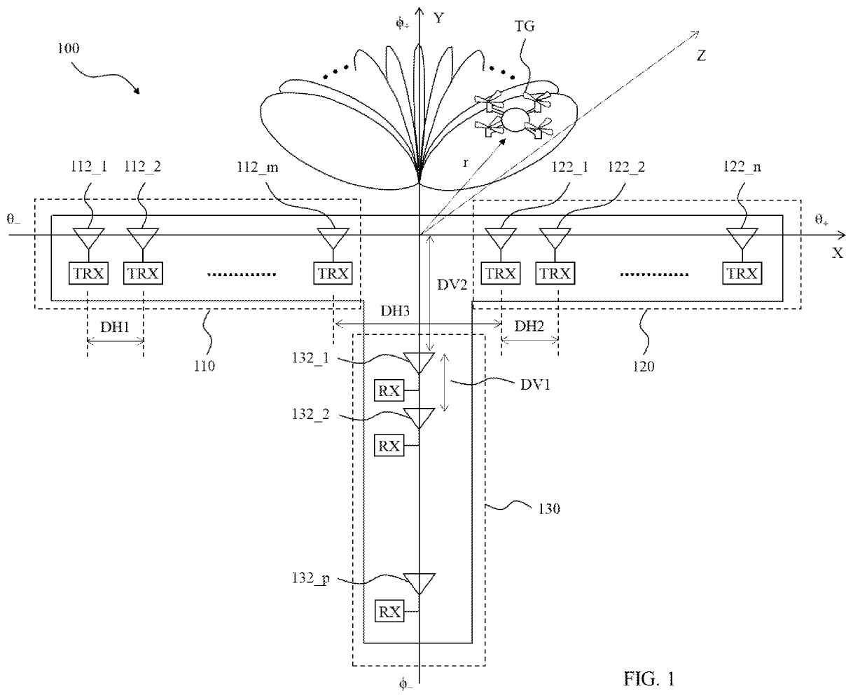

FIG. 1 is a diagram illustrating an exemplary radar system in accordance with some embodiments of the present disclosure. The radar system 100 can utilize phased array architecture to implement an S-band radar or an AESA radar. The radar system 100 may include a plurality of subarrays 110, 120 and 130. The subarray 110 may include a plurality of antennas 112_1-112_m arranged along a first direction; the subarray 120 may include a plurality of antennas 122_1-122_n arranged along the first direction; the subarray 130 may include a plurality of antennas 132_1-132_p arranged along a second direction orthogonal to the first direction. The phased array architecture implemented by the subarrays 110-130 can be referred to as a T-shaped array, and the radar system 100 can be referred to as a T-shaped radar system.

In the present embodiment, the first direction can be a horizontal direction parallel to the X-axis, and the second direction can be a vertical direction parallel to the Y-axis. The subarray 110 can be referred to as a horizontal left subarray (HLS). Each antenna of the subarray 110 (i.e. one of the antennas 112_1-112_m) can be referred to as a horizontal antenna, and the spacing DH1 between adjacent two horizontal antennas can be, but is not limited to, half of a beam wavelength (e.g. a wavelength of a signal transmitted by the subarray 110). Each horizontal antenna is part of a corresponding transceiver (labeled as TRX) that can be formed or mounted on a circuit board (not shown in FIG. 1). The transceiver TRX may include, but is not limited to, radio frequency (RF) front-end circuitry, analog front-end circuitry, and digital signal and data processor (DSDP) circuitry (not shown in FIG. 1) for both signal transmission and reception.

Similarly, the subarray 120 can be referred to as a horizontal right subarray (HRS). Each antenna of the subarray 120 (i.e. one of the antennas 122_1-122_n) can be referred to as a horizontal antenna, and the spacing DH2 between adjacent two horizontal antennas can be, but is not limited to, half of a beam wavelength (e.g. a wavelength of a signal transmitted by the subarray 120). Each horizontal antenna is part of a corresponding transceiver (labeled as TRX) that can be formed or mounted on a circuit board (not shown in FIG. 1). The transceiver TRX may include, but is not limited to, RF front-end circuitry, analog front-end circuitry, and DSDP circuitry (not shown in FIG. 1) for both signal transmission and reception.

In the present embodiment, the spacing DH3 between the antenna 122_1 of the subarray 120 and the antenna 112_m of the subarray 110 can be greater than or equal to the spacing DH1/DH2. In a case where the spacing DH3 is greater than the spacings DH1 and DH2, the subarrays 110 and 120 can jointly considered as a non-uniform linear array (NLA). In addition, the subarrays 110 and 120 can have a symmetric structure, facilitating folding on both sides of the subarray 130. For example, the number of antennas in the subarray 110 can be equal to the number of antennas in the subarray 120 (i.e. m is equal to n). The number of antennas in the subarray 130 can also be equal to the number of antennas in the subarray 110/120.

Additionally, the subarray 130 can be referred to as a vertical subarray (VS). Each antenna of the subarray 130 (i.e. one of the antennas 132_1-132_p) can be referred to as a vertical antenna. Each vertical antenna is part of a corresponding receiver (labeled as RX) that can be mounted or formed on a circuit board (not shown in FIG. 1). The receiver RX may include, but not limited to, RF front-end circuitry, analog front-end circuitry, and DSDP circuitry (not shown in FIG. 1) for signal reception. The subarray 130 can be regarded as a uniform linear array (ULA), and the spacing DV1 between adjacent two antennas can be, but is not limited to, half of a beam wavelength (e.g. a wavelength of a signal transmitted by the subarray 130).

In the present embodiment, for illustrative purposes, the midpoint of the subarrays 110 and 120 can be positioned at the origin of the XYZ coordinate system, and serve as a reference point for the radar system 100. The receiver RX including the antenna 132_1 in the subarray 130 can be positioned below the reference point at a distance DV2 from the XZ plane. Additionally, in the spherical coordinate system, the detection range of the radar system 100 can be represented by the radial range r. A coordinate point with an azimuth angle θ greater than zero is located to the right of the YZ plane, and a coordinate point with an azimuth angle θ less than zero is located to the left of the YZ plane. A coordinate point with an elevation angle ϕ greater than zero is located above the XZ plane, and a coordinate point with an elevation angle ϕ less than zero is located below the XZ plane. When the target TG approaches or moves away from the radar system 100, its radial velocity is respectively greater than 0 or less than 0.

In operation, the subarrays 110 and 120 can be configured to emit fan beams with different orientations, thereby performing fan-beam scanning on coverage areas oriented in different directions. Each fan beam can be horizontally narrow and vertically wide. When the target TG is located within the scanning range of the radar system 100, the subarrays 110-130 can obtain the position information of the target TG according to signals reflected from the target TG. For example, the subarray 130 can combine/merge a first set of data received from the subarray 110 and a second set of data received from the subarray 120 into a combined set of data, and apply beamforming to the combined set of data to thereby generate first beamformed data indicating target azimuth information. This combined set of data can be a set of Doppler processed data. As another example, the subarray 130 can generate second beamformed data indicating target elevation information according to signals received by antennas 132_1-132_p (e.g. input signals reflected from the target TG). Thus, the radar system 100 can simultaneously obtain the azimuth and elevation angles of the target TG (both used to represent the angle of arrival of the target TG), facilitating target positioning in the three-dimensional space. Compared to a two-dimensional planar array, the proposed two-dimensional sparse orthogonal linear array can significantly reduce manufacturing costs and effectively perform target positioning.

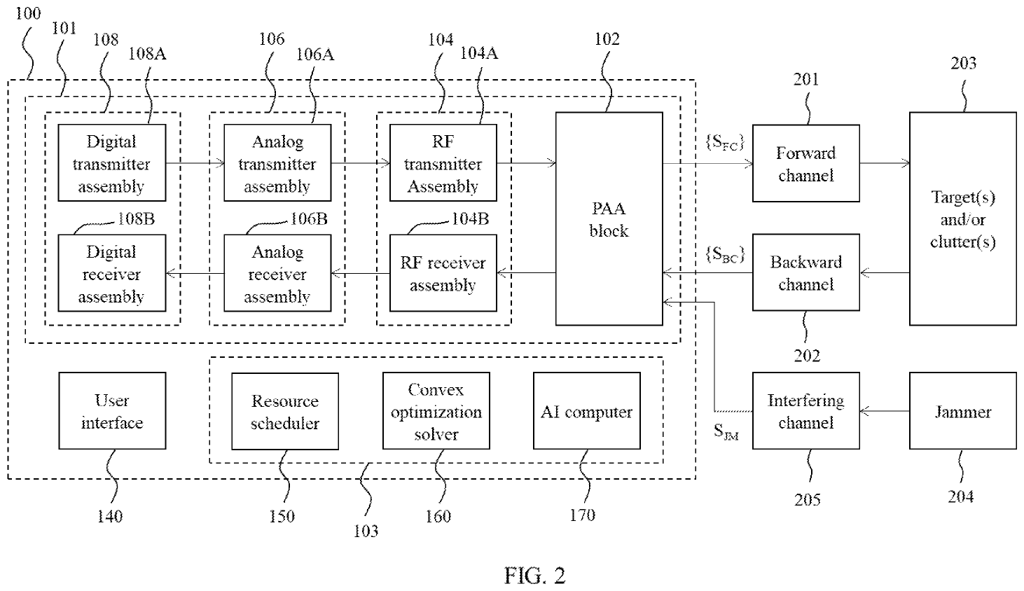

FIG. 2 is a block diagram of the radar system 100 shown in FIG. 1 in accordance with some embodiments of the present disclosure. In the present embodiment, the radar system 100 can be implemented using a two-way monostatic configuration. The radar system 100 may include, but is not limited to, a transceiver block 101, a control block 103 and a user interface 140. The transceiver block 101 may include a phased array antenna (PAA) block 102, an RF front-end circuit (RFE) block 104, an analog front-end circuit (AFE) block 106, and a DSDP block 108.

The PAA block 102 is configured for transmission and reception of electromagnetic wave signals. The PAA block 102 may include the antennas 112_1-112_m, 122_1-122_n and 132_1-132_p shown in FIG. 1, which can use variable phase shifters and/or time-delay controllers (not shown in FIG. 2) to steer the beam of radio waves to an appointed direction

The RFE block 104 is configured for processing RF signals. The RFE block 104 may include, but is not limited to, mixers (for upconversion and/or downconversion), power amplifiers (PAS), low-noise amplifiers (LNAs), transceiver switches (for switching between transmission and reception), and bandpass filters (not shown in FIG. 2). In the present embodiment, the RFE block 104 may include an RF transmitter assembly 104A and an RF receiver assembly 104B. By way of example but not limitation, the RF transmitter assembly 104A may include power amplifiers; the RF receiver assembly 104B may include mixers, low-noise amplifiers, transceiver switches, and bandpass filters.

The AFE block 106 is configured for processing analog signals. The AFE block 106 may include, but is not limited to, analog-to-digital converters (ADCs), digital-to-analog converters (DACs), programmable gain amplifiers (PGAs), and lowpass filters. In the present embodiment, the AFE block 106 may comprise an analog transmitter assembly 106A and an analog receiver assembly 106B. By way of example but not limitation, the analog transmitter assembly 106A may include analog-to-digital converters; the analog receiver assembly 106B may include digital-to-analog converters, programmable gain amplifiers, and lowpass filters.

The DSDP block 108 is configured for processing digital signals and data. The DSDP block 108 may include, but is not limited to, pulse waveform generation circuits and algorithm modules, such as matched filtering modules, Doppler processing modules, and beamforming modules. In the present embodiment, the DSDP block 108 may include a digital transmitter assembly 108A and a digital receiver assembly 108B. By way of example but not limitation, the digital transmitter assembly 108A may include pulse waveform generation circuits; the digital receiver assembly 108B may include algorithm modules.

The control block 103 can be configured to control the operation of the transceiver block 101, and/or provide relevant configuration settings for the operation of the transceiver block 101. The control block 103 may include, but is not limited to, a resource scheduler 150, a convex optimization solver 160, and an artificial intelligence (AI) computer 170. The resource scheduler 150 is configured to determine the beam scanning strategies/modes and the required signal formats/parameters, such as the lengths of the pulse duration, the pulse repetition interval (PRI) and the coherent processing interval (CPI). For example, the number of beams used for beam scanning may be proportional to the length of the one-round scan interval (e.g. the time required for the radar system 100 to complete one-round scan operation over the entire scanning range). The choices of signal formats are highly related to the resulting signal-to-noise ratio (SNR), target resolution, detectability in the range domain, and detectability in the velocity domain.

The convex optimization solver 160 may be closely associated with the resource scheduler 150. Based on the optimization problem formulated and built into the radar system 100, the convex optimization solver 160 can be used to instantly obtain suitable or optimal signal parameters. Additionally, the convex optimization solver 160 can optimize the pulse waveforms at the transmitter sides, as well as optimize the window coefficients applied to Doppler processing and beamforming at the receiver sides. Furthermore, with the use of huge amounts of data continually obtained, the AI computer 170 can assist in recognizing target features, clutter characteristics and jammer behaviors, modeling the surrounding environment, and tuning DSDP module variables. The user interface 140, such as a graphical user interface (GUI), can allow users to interact with the radar system 100 for scan configuration and monitoring.

In operation, the transceiver block 101 can emit radiated signals {SFC} via the forward channels 201 to the target(s) and/or clutter object(s) 203 in the scanning area according to the configuration provided by the control block 103 (such as signal parameters/formats). Next, the transceiver block 101 can receive reflected signals {S_{BC}} from the target(s) and/or clutter object(s) 203 via the backward channels 202. The forward channels 201 and the backward channels 202 may have substantially similar/identical physical properties. If the jammer 204 exists, and the jamming signals SIM can be sent over the one-way interfering channels 205 to the PAA block 102 to thereby deteriorate the radar detection performance. In conjunction with the control block 103, the transceiver block 101 can obtain target information, and mitigate the impact of clutter and the jamming signals SIM on target recognition.

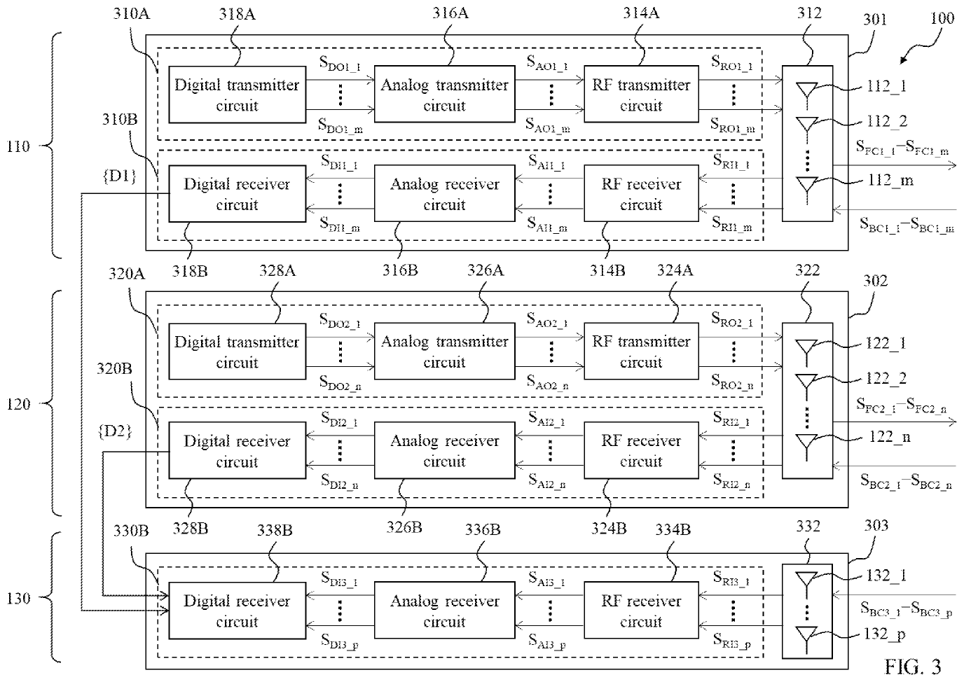

FIG. 3 is an implementation of the radar system 100 shown in FIG. 2 in accordance with some embodiments of the present disclosure. A portion or all of the transceiver block 101 shown in FIG. 2 can be implemented using the subarrays 110-130. In the present embodiment, the subarrays 110 and 120 can be implemented as transceiver circuitry, and the subarray 130 can be implemented as receiver circuitry.

By way of example but not limitation, the subarray 110 can be formed on the circuit board 301, and may include a phased array antenna circuit 312, a signal generator circuit 310A and a signal processing circuit 310B. The circuit board 301 may be implemented using a printed circuit board, a composite material substrate, a metal substrate, a ceramic substrate, or other types of circuit boards. The phased array antenna circuit 312 may be implemented using the antennas 112_1-112_m shown in FIG. 1. The phased array antenna circuit 312 can be configured to transmit the radiated signals S_{FC1_1}-S_{FC1_m} according to the electrical signals S_{RO1_1}-S_{RO1_m}, and receive the input signals S_{BC1_1}-S_{BC1_m} to generate the electrical signals S_{RI1_1}-S_{RI1_m}. The phased array antenna circuit 312 can serve as an embodiment of a portion of the PAA block 102 shown in FIG. 2; the radiated signals S_{FC1_1}-S_{FC1_m} can serve as an embodiment of a portion of the radiated signals {SFC} shown in FIG. 2; the input signals S_{BC1_1}-S_{BC1_m} can serve as an embodiment of a portion of the reflected signals {S_{BC}} shown in FIG. 2.

The signal generator circuit 310A is configured to generate a plurality of electrical signals S_{RO1_1}-S_{RO1_m}. The signal generator circuit 310A may include an RF transmitter circuit 314A, an analog transmitter circuit 316A and a digital transmitter circuit 318A. The RF transmitter circuit 314A can serve as an embodiment of a portion of the RF transmitter assembly 104A shown in FIG. 2; the analog transmitter circuit 316A can serve as an embodiment of a portion of the analog transmitter assembly 106A shown in FIG. 2; the digital transmitter circuit 318A can serve as an embodiment of a portion of the digital transmitter assembly 108A shown in FIG. 2. In the present embodiment, the RF transmitter circuit 314A is configured to generate the electrical signals S_{RO1_1}-S_{RO1_m} according to the electrical signals S_{AO1_1}-S_{AO1_m}; the analog transmitter circuit 316A is configured to generate the electrical signals S_{AO1_1}-S_{AO1_m} according to the electrical signals S_{DO1_1}-S_{DO1_m}; the digital transmitter circuit 318A is configured to generate the electrical signals S_{DO1_1}-S_{DO1_m}.

The signal processing circuit 310B, coupled to the antennas 112_1-112_m, is configured to process the electrical signals S_{RI1_1}-S_{R11_m} received from the antennas 112_1-112_m to generate a set of data {D1}. The signal processing circuit 310B may include an RF receiver circuit 314B, an analog receiver circuit 316B and a digital receiver circuit 318B. The RF receiver circuit 314B may serve as an embodiment of a portion of the RF receiver assembly 104B shown in FIG. 2, the analog receiver circuit 316B may serve as an embodiment of a portion of the analog receiver assembly 106B shown in FIG. 2, and the digital receiver circuit 318B may serve as an embodiment of a portion of the digital receiver assembly 108B shown in FIG. 2. In the present embodiment, the RF receiver circuit 314B is configured to generate the electrical signals S_{AI1_1}-S_{AI1_m} according to the electrical signals S_{RI1_1}-S_{RI1_m}; the analog receiver circuit 316B is configured to generate the electrical signals S_{DI1_1}-S_{DI1_m} according to the electrical signals S_{AI1_1}-S_{AI1_m}; the digital receiver circuit 318B is configured to generate the set of data {D1} according to the electrical signals S_{DI1_1}-S_{DI1_m}.

The subarray 120 may have a structure substantially similar/identical to that of the subarray 110. The subarray 120 may be formed on the circuit board 302, and include a phased array antenna circuit 322, a signal generator circuit 320A and a signal processing circuit 320B. The circuit board 302 may be implemented using a printed circuit board, a composite material substrate, a metal substrate, a ceramic substrate, or other types of circuit boards. The phased array antenna circuit 322 can be implemented using the antennas 122_1-122_n shown in FIG. 1. The phased array antenna circuit 322 can be configured to generate the radiated signals S_{FC2_1}-S_{FC2_n} according to the electrical signals S_{RO2_1}-S_{RO2_n}, and receive the input signals S_{BC2_1}-S_{BC2_n} to generate the electrical signals S_{RI2_1}-S_{RI2_n}. The phased array antenna circuit 322 can serve as an embodiment of a portion of the PAA block 102 shown in FIG. 2; the radiated signals S_{FC2_1}-S_{FC2_n} can serve as an embodiment of a portion of the radiated signals {SFC} shown in FIG. 2; the input signals S_{BC2_1}-S_{BC2_n} can serve as an embodiment of a portion of the reflection signals {S_{BC}} shown in FIG. 2.

The signal generator circuit 320A is configured to generate the electrical signals S_{RO2_1}-S_{RO2_n}. The signal generator circuit 320A may include an RF transmitter circuit 324A, an analog transmitter circuit 326A and a digital transmitter circuit 328A. The RF transmitter circuit 324A can serve as an embodiment of a portion of the RF transmitter assembly 104A shown in FIG. 2; the analog transmitter circuit 326A can serve as an embodiment of a portion of the analog transmitter assembly 106A shown in FIG. 2; the digital transmitter circuit 328A can serve as an embodiment of a portion of the digital transmitter assembly 108A shown in FIG. 2. In the present embodiment, the RF transmitter circuit 324A is configured to generate the electrical signals S_{RO2_1}-S_{RO2_n} according to the electrical signals S_{AO2_1}-S_{AO2_n}; the analog transmitter circuit 326A is configured to generate the electrical signals S_{AO2_1}-S_{AO2_n} according to the electrical signals S_{DO2_1}-S_{DO2_n}; the digital transmitter circuit 328A is configured to generate the electrical signals S_{DO2_1}-S_{DO2_n}.

The signal processing circuit 320B, coupled to the antennas 122_1-122_n, is configured to process the electrical signals S_{RI2_1}-S_{RI2_n} received from the antennas 122_1-122_n to generate a set of data {D2}. The signal processing circuit 320B may include an RF receiver circuit 324B, an analog receiver circuit 326B and a digital receiver circuit 328B. The RF receiver circuit 324B can serve as an embodiment of a portion of the RF receiver assembly 104B shown in FIG. 2; the analog receiver circuit 326B can serve as an embodiment of a portion of the analog receiver assembly 106B shown in FIG. 2; the digital receiver circuit 328B can serve as an embodiment of a portion of the digital receiver assembly 108B shown in FIG. 2. In the present embodiment, the RF receiver circuit 324B is configured to generate the electrical signals S_{AI2_1}-S_{AI2_n} according to the electrical signals S_{RI2_1}-S_{RI2_n}; the analog receiver circuit 326B is configured to generate the electrical signals S_{DI2_1}-S_{DI2_n} according to the electrical signals S_{AI2_1}-S_{AI2_n}; the digital receiver circuit 328B is configured to generate the set of data {D2} according to the electrical signals S_{DI2_1}-S_{DI2_n}.

In addition, the subarray 130 can be formed on the circuit board 303, and include a phased array antenna circuit 332 and a signal processing circuit 330B. The circuit board 303 can be electrically connected to each of the circuit boards 301 and 302, which are separated from each other. The circuit board 303 may be implemented using a printed circuit board, a composite material substrate, a metal substrate, a ceramic substrate, or other types of circuit boards. The phased array antenna circuit 332 can be implemented using the antennas 132_1-132_p shown in FIG. 1, and configured to receive the input signals S_{BC3_1}-S_{BC3_p} to generate the electrical signals S_{RI3_1}-S_{RI3_p}. The phased array antenna circuit 332 can serve as an embodiment of a portion of the phased array antenna block 102 shown in FIG. 2, and the input signals S_{BC3_1}-S_{BC3_p} can serve as an embodiment of a portion of the reflection signals {S_{BC}} shown in FIG. 2.

The signal processing circuit 330B is coupled to the signal processing circuit 310B, the signal processing circuit 320B and the antennas 132_1-132_p. The signal processing circuit 330B is configured to generate first beamformed data according to the set of data {D1} and the set of data {D2}. The first beamformed data can indicate target azimuth information. In the present embodiment, the signal processing circuit 330B can be configured to combine the sets of data {D1} and {D2} output from the subarrays 110 and 120, and accordingly perform beamforming (e.g. horizontal beamforming) in a direction along which the antennas of the subarrays 110 and 120 are arranged (i.e. the first direction). For example, the signal processing circuit 330B may merge/combine the set of data {D1} and the set of data {D2} into a combined set of data, and apply beamforming to the combined set of data to thereby generate the first beamformed data.

In addition, the signal processing circuit 330B can be further configured to perform beamforming (e.g. vertical beamforming) in a direction along which the antennas 132_1-132_p are arranged (i.e. the second direction) according to the electrical signals S_{RI3_1}-S_{RI3_p} received from the antennas 132_1-132_p. For example, the signal processing circuit 330B can be configured to process the electrical signals S_{RI3_1}-S_{RI3_p} received from the antennas 132_1-132_p to generate a set of data, and further configured to generate second beamformed data indicating target elevation information according to the generated set of data. In some examples, the signal processing circuit 330B may rectify/correct azimuth angles obtained from horizontal beamforming according to the target elevation information (e.g. an estimation result of target elevation angles).

The signal processing circuit 330B may include an RF receiver circuit 334B, an analog receiver circuit 336B and a digital receiver circuit 338B. The RF receiver circuit 334B can serve as an embodiment of a portion of the RF receiver assembly 104B shown in FIG. 2; the analog receiver circuit 336B can serve as an embodiment of a portion of the analog receiver assembly 106B shown in FIG. 2; the digital receiver circuit 338B can serve as an embodiment of a portion of the digital receiver assembly 108B shown in FIG. 2. In the present embodiment, the RF receiver circuit 334B is configured to generate the electrical signals S_{AI3_1}-S_{AI3_p} according to the electrical signals S_{RI3_1}-S_{RI3_p}; the analog receiver circuit 336B is configured to generate the electrical signals S_{DI3_1}-S_{DI3_P} according to the electrical signals S_{AI3_1}-S_{AI3_p}; the digital receiver circuit 338B is configured to generate the target information according to the set of data {D1}, the set of data {D2}, and the electrical signals S_{DI3_1}-S_{DI3_p}.

By converging the set of data {D1} outputted from the subarray 110 and the set of data {D2} outputted from the subarray 120 to the subarray 130, the proposed radar system not only can simplify the circuit design and the signal processing architecture, but also can check/correct the signal processing results to thereby enhance the accuracy of target detection.

In some embodiments, the control block 103 shown in FIG. 1 may be implemented in the subarray 130. For example, the control block 103 shown in FIG. 1 may be arranged on the circuit board 303. In some embodiments, the control block 103 may be implemented outside the subarrays 110-130. In some embodiments, the control block 103 may be implemented in the subarrays 110-130 in a distributed manner. By way of example but not limitation, a first part of the resource scheduler 150 shown in FIG. 1 may be implemented in the subarray 110 to determine signal parameters related to the pulses sent by the subarray 110; a second part of the resource scheduler 150 may be implemented in the subarray 120 to determine signal parameters related to the pulses sent by the subarray 120; a third part of the resource scheduler 150 may be implemented in the subarray 130 to determine signal parameters related to the one-round beam scanning using the subarrays 110 and 120.

To facilitate understanding of the present disclosure, the proposed radar signal processing scheme is described below with reference to a radar system that utilizes multiple detection distance ranges for scanning targets. Those skilled in the art should appreciate that the radar signal processing scheme described below can be applied to various radar systems, which utilize two-dimensional sparse orthogonal linear phased arrays for detecting, tracking and/or identifying targets in the three-dimensional space, without departing from the scope of the present disclosure. Other radar systems using the signal processing architecture shown in FIG. 2 and/or FIG. 3 fall within the scope and spirit of the present disclosure.

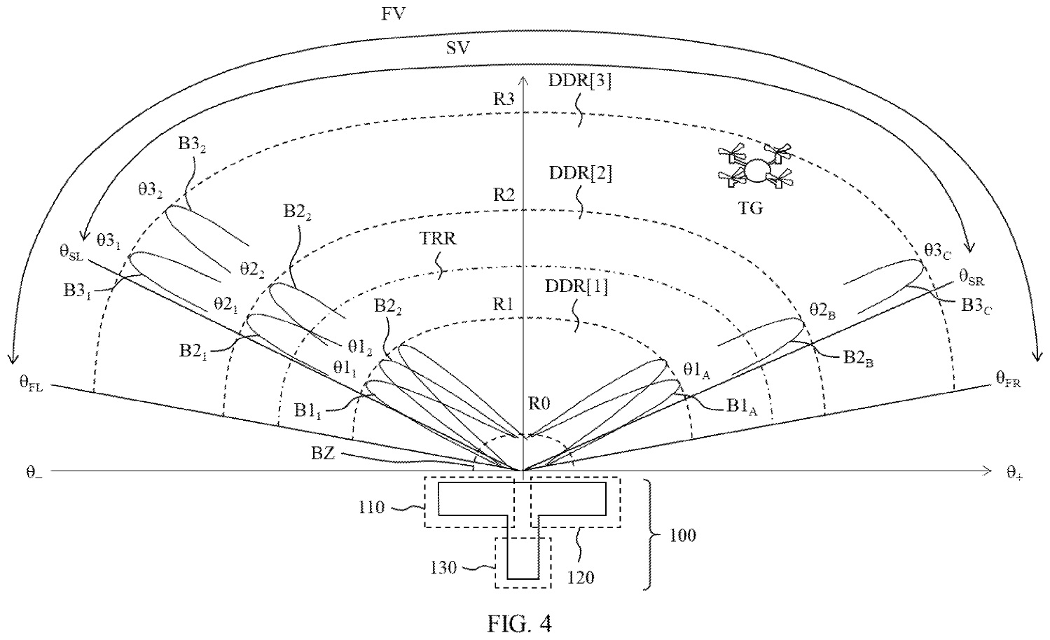

Referring firstly to FIG. 4, a top view of the radar system 100 shown in FIG. 1 configured for target detection is illustrated in accordance with some embodiments of the present disclosure. The scanning capability of the radar system 100 is indicated by the field of view (FoV) FV in terms of the scannable range (a distance in the radial direction r from the radar system 100), the azimuth coverage and the elevation coverage. For example, the minimum scannable range of the radar system 100 is R0 (e.g. 100 meters or the outer edge of the blind zone BZ), the maximum scannable range is R3 (e.g. 5 kilometers), the azimuth coverage is between the azimuth angle θ_{FL} (e.g. −60 degrees) and the azimuth angle θ_{FR} (e.g. +60 degrees), and the elevation coverage is between two elevation angles (e.g. −60 degrees and +60 degrees).

The location and posture of the radar system 100 can be fixed. The radar system 100 can utilize beamforming to steer a plurality of fan beams to different azimuth angles without mechanical motion, and accordingly perform beam scanning. In the present embodiment, the scannable range of the radar system 100 can be divided into a plurality of detection distance ranges DDR [1]-DDR [3], which employ different signal formats/parameters to meet predetermined or substantially the same SNR requirement. Additionally, the radar system 100 can set a beam scanning volume SV (between the azimuth angles θ_{SL} and θ_{SR}) based on usage requirements/scenarios, and the beam scanning volume SV is smaller than or equal to the field of view FV. The radar system 100 can perform target detection, tracking and/or recognition in the beam scanning volume SV with the use of segmented scanning ranges.

Referring to FIG. 4 and also to FIG. 3, in a scanning mode, the subarrays 110 and 120 can perform beam scanning by emitting the beams B1₁-B1_{A} towards the azimuth angles θ1₁-θ1_{A} respectively, emitting the beams B2₁-B2_{B} towards the azimuth angles θ2-θ2_{B} respectively, and emitting the beams B3₁-B3_{C} towards the azimuth angles θ3₁-θ3_{C} respectively, where A, B and Care positive numbers. For example, the digital transmitter circuits 318A and 328A can send the electrical signals S_{DO1_1}-S_{DO1_m} and S_{DO2_1}-S_{DO2_n}, respectively, according to the signal format/parameters determined by the resource scheduler 150 shown in FIG. 2, thereby enabling the phased array antenna circuits 312 and 322 to emit the radiated signals S_{FC1_1}-S_{FC1_m} and S_{FC2_1}-S_{FC2_n} that can form the beam B1₁ directed towards the azimuth angle θ1₁.

In the present embodiment, the radar system 100 can perform multiple rounds of scanning in the beam scanning volume SV, and scan the detection distance ranges DDR [1]-DDR [3] in sequence in each round of scanning. By way of example but not limitation, in each round of scanning, the radar system 100 can firstly generate the beams B1₁-B1_{A} in sequence to scan the detection distance range DDR [1] (between the detection distances R0 and R1), generate the beams B2₁-B2_{B} in sequence to scan the detection distance range DDR [2] (between the detection distances R1 and R2), and then generate the beams B3₁-B3_{C} in sequence to scan the detection distance range DDR [3] (between the detection distances R2 and R3), thereby completing the round of scanning. In addition, the radar system 100 can use the same set of azimuth angles to uniformly scan each detection distance range DDR [d] (d=1, 2, 3). For example, the beams B1₁-B1_{A}, B2₁-B2_{B} and B3₁-B3_{C} have the same number of beams (i.e. A, B and C are equal to each other), and θ1ᵢ, θ2ᵢ and θ3ᵢ (i=1, 2, . . . , A) are equal to each other.

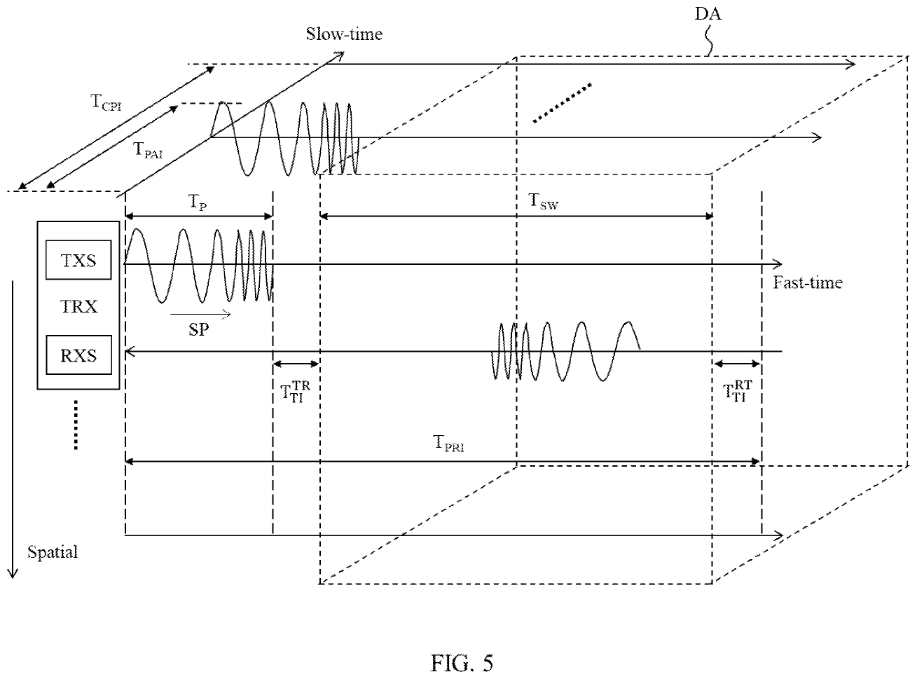

After the radar system 100 emits an RF beam, the subarrays 110-130 can process the received input signals S_{BC1_1}-S_{BC1_m}, S_{BC2_1}-S_{BC2_n} and S_{BC3_1}-S_{BC3_p} within a predetermined time interval for target detection. FIG. 5 is a timing diagram of the transceiver architecture shown in FIG. 3 in one CPI (having a time duration T_{CPI}) in accordance with some embodiments of the present disclosure. Referring to FIG. 5 and also to FIG. 3, the transmitter side TXS in the transceiver TRX (e.g. the antenna 112_1 and corresponding transmitter circuits shown in FIG. 3, or the signal transmission circuit in the transceiver TRX corresponding to the antenna 112_1 shown in FIG. 1) sends a pulse signal SP (e.g. the radiated signal S_{FC1_1} shown in FIG. 3) with the pulse duration T_{P} in the fast-time axis. The pulse duration T_{P} can be set as the product of the number of samples per pulse signal and the sampling interval of the analog-to-digital conversion. After a transient interval T_{TI}^{TR} (e.g. the interval between deactivation of the signal generator circuit 310A and activation of the signal processing circuit 310B), the receiver side RXS in the transceiver TRX (e.g. the antenna 112_1 and corresponding receiver circuits shown in FIG. 3, or the signal reception circuit in the transceiver TRX corresponding to the antenna 112_1 shown in FIG. 1) can be activated for a swath duration T_{SW} to receive and process a reflected signal SR (e.g. the input signal S_{BC1_1}). After another transient interval TA (e.g. the interval between the deactivation of the signal processing circuit 310B and the activation of the signal generator circuit 310A), the transmitter side TXS can send the pulse signal SP again. In other words, the transmitter side TXS can send a pulse signal each time a pulse repetition interval (PRI) with a time duration T_{PRI} has elapsed.

In the present embodiment, other transceivers (e.g. the antennas 112_2-112_m and associated transmitter circuits shown in FIG. 3, or the signal transmitter circuits in the transceivers TRX corresponding to the antennas 112_2 to 112_m shown in FIG. 1) are also arranged along the spatial axis. For the sake of brevity, FIG. 5 merely illustrates the timing of signal transmission and reception associated with one transceiver in the spatial axis. The timing of signal transmission and reception timing associated with other transceivers can be substantially identical to that associated with the transceiver described above with reference to FIG. 5.

Note that the proposed DSDP scheme can simplify signal processing architecture and maintain good radar detection quality. For example, one or more PRIs can serve as a pulse averaging interval (PAI) (having a time duration T_{PAI} indicated in the slow-time axis). The DSDP scheme implemented by the digital receiver circuits 318A, 318B and 318C can pre-average the amount of data obtained within one PAI, and perform associated calculations on the data DA (which can be structured or organized as a datacube) obtained in one CPI including one or more PAIs to thereby generate target information.

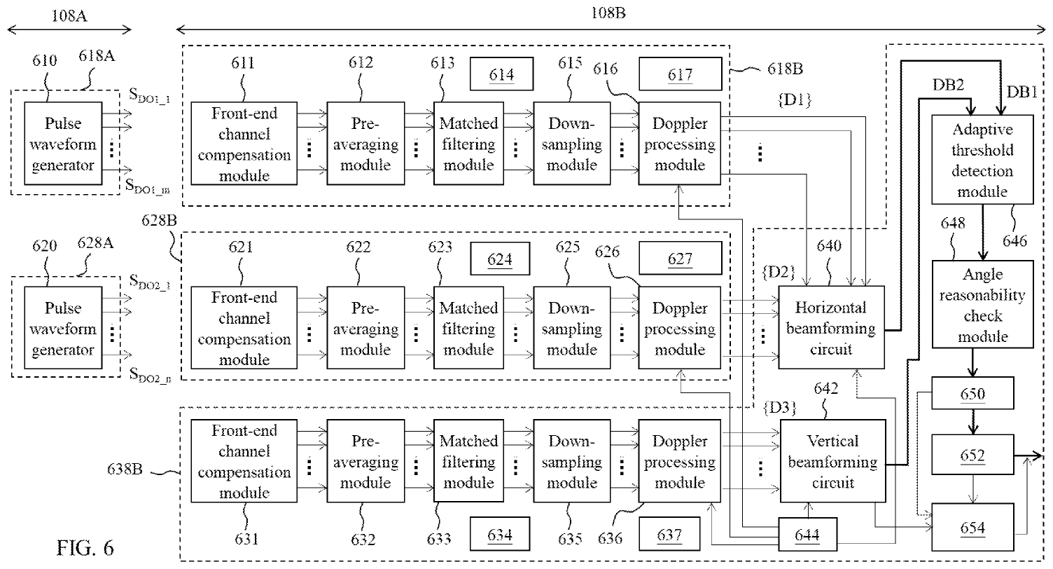

Referring to FIG. 6, an implementation of the digital transmitter assembly 108A and the digital receiver assembly 108B shown in FIG. 1 is illustrated in accordance with some embodiments of the present disclosure. The digital transmitter assembly 108A may include, but is not limited to, a digital transmitter circuit 618A and a digital transmitter circuit 628A, which can serve as embodiments of the digital transmitter circuits 318A and 328A shown in FIG. 3 respectively. The digital transmitter circuit 618A may include a pulse waveform generator 610, which is configured to generate a plurality of pulse signals with pulse compression waveforms. The generated pulse signals serve as the electrical signals S_{DO1_1}-S_{DO1_m}. By way of example but not limitation, the pulse waveform generator 610 can utilize a linear frequency modulated (LFM) waveform, also known as a chirp waveform, to generate a complex-valued discrete-time LFM chirp pulse signal. In some embodiments, the pulse waveform generator 610 may generate a suitable pulse waveform according to signal parameters obtained by the convex optimization solver 160 shown in FIG. 1. For example, the convex optimization solver 160 shown in FIG. 1 can obtain a pulse waveform that minimizes the maximum sidelobe peak, subject to the constraints of controllable spectral leakage, constant modulus and fixed energy.

Similarly, the digital transmitter circuit 628A may include a pulse waveform generator 620, which is configured to generate a plurality of pulse signals with pulse compression waveforms. The generated pulse signals serve as the electrical signals S_{DO2_1}-S_{DO2_n}. The pulse waveform generator 620 may have a design and operation similar/identical to that of the pulse waveform generator 610. In other words, the pulse waveform generator 620 can generate the electrical signals S_{DO2_1}-S_{DO2_n} according to the signal formats/parameters determined by the control block 103 shown in FIG. 1.

The digital receiver assembly 108B may include digital receiver circuits 618B, 628B and 638B, which can serve as embodiments of the digital transmitter circuits 318B, 328B and 338B shown in FIG. 3 respectively. Each digital receiver circuit may use a plurality of modules to process the received discrete-time signal samples (i.e. the electrical signals S_{DI1_1}-S_{DI1_m}, S_{DI2_1}-S_{DI2_n} and S_{DI3_1}-S_{DI3_p}) to generate a set of data that can be structured or organized as a datacube. For example, each digital receiver circuit may perform at least matched filtering and/or Doppler processing on the received discrete-time signal samples to generate a set of data that can be structured as a datacube. Note that the “modules” described herein can be algorithm modules implemented by software, circuits implemented by hardware, or firmware architectures implemented by a combination of software and hardware.

For example, the digital receiver circuit 618B may include, but is not limited to, a front-end channel compensation module 611, a pre-averaging module 612, a matched filtering module 613, a matched pulse generator module 614, a downsampling module 615, a Doppler processing module 616, and a chirp Z-transform module 617. In a case where one of the above modules in the digital receiver circuit 618B is implemented using an algorithm module, this algorithm module is operated by the computing resources of the subarray 110. In a case where one of the above modules in the digital receiver circuit 618B is implemented by a hardware circuit, this hardware circuit is installed on a circuit board corresponding to the subarray 100 (e.g. the circuit board 301 shown in FIG. 3). In a case where one of the above modules in the digital receiver circuit 618B is implemented by a firmware architecture, this firmware architecture is installed on a circuit board corresponding to the subarray 100 (e.g. the circuit board 301 shown in FIG. 3), and utilizes the computing resources of the subarray 110 to execute associated algorithms.

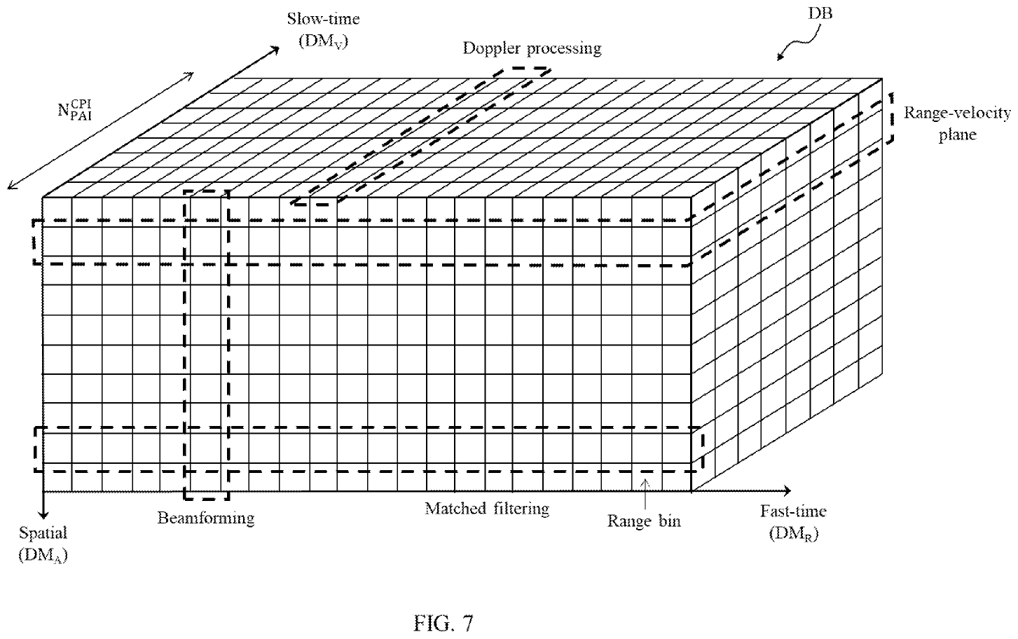

FIG. 7 is a diagram illustrating the datacube format processed by the digital receiver assembly 108B shown in FIG. 6 in accordance with some embodiments of the present disclosure. The datacube DB shown in FIG. 7 (represented in the range domain DM_{R}, velocity domain DM_{V} and angular domain DM_{A}) can serve as an embodiment of the datacube formed based on the data DA shown in FIG. 5. Referring to FIG. 6 and FIG. 7, in some example where the datacube DB is obtained using the subarray 110 shown in FIG. 1, a cell can represent a reflected signal received by one of the antennas 112_1-112_m (corresponding to the spatial axis or receiver axis) shown in FIG. 1 at a time point (corresponding to the fast-time axis) during a period of time (corresponding to the slow-time axis). Each cell can be a complex-valued sample. The spatial axis, the slow-time axis and the fast-time axis can correspond to the angular domain DM_{A} (which can represent an azimuth angle of a target), the velocity domain DM_{V} (which can represent a velocity of a target) and the range domain DM_{R} (which can represent a distance of a target), respectively.

In the embodiment shown in FIG. 6, a plurality of discrete-time signal samples (i.e. the electrical signals S_{DI1_1}-S_{DI1_m}) are inputted to the front-end channel compensation module 611, which can be configured to compensate for changes in the in-phase and quadrature (I-Q) channel responses of the RF front-end circuits (e.g. the RF transmitter circuit 314A and the RF receiver circuit 314B shown in FIG. 3) and the analog front-end circuits (e.g. the analog transmitter circuit 316A and the analog receiver circuit 316B shown in FIG. 3) caused by environmental variations (e.g. temperature variations). For example, the front-end channel compensation module 611 may compensate for I-Q imbalance, gain and phase offsets of the in-phase/quadrature channels, and/or DC offset, to thereby output the compensated electrical signals S_{DI1_1}-S_{DI1_m}.

The pre-averaging module 612 is configured to perform pre-averaging upon the compensated electrical signals S_{DI1_1}-S_{DI1_m} within a pre-averaging time interval (which can be represented by PAI), thereby reducing the data throughput processed by the digital receiver circuit 618B. The total length of the one CPI remains unchanged and can be represented as follows:

$${T}_{CPI} [ d ] = {N}_{PRI}^{CPI} [ d ] {T}_{PRI} [ d ] = {N}_{PAI}^{CPI} [ d ] {N}_{PRI}^{PAI} [ d ] {T}_{PRI} [ d ] , ∀ d ∈ \{ 1 , 2 , … , {N}_{DDR} \} ,$$

where T_{CPI} represents the length of one CPI, N_{PRI}^{CPI} represents the number of PRIs within one CPI, T_{PRI} represents the length of one PRI, T_{PRI} represents the number of PAIs within one CPI, N_{PRI}^{PAI} represents the number of PRIs within one PAI, and N_{DDR} represents the number of detection distance ranges. For example, in a case where beam scanning is performed in the detection distance range DDR [1] shown in FIG. 4 is scanned, the length of the CPI (T_{CPI}[1]) is equal to the product of the number of PRIs (N_{PRI}^{CPI}[1]) and the length of the PRI (T_{PRI}[1]), and the number of PRIs is equal to the product (N_{PAI}^{CPI}[1]N_{PRI}^{PAI}[1]) of the number of PAIs (N_{PAI}^{CPI}[1]) and the number of PRIs within one PAI (N_{PRI}^{PAI}[1]).

The matched filtering module 613 is configured to convolve the output of the pre-averaging module 612 with the matched pulse generated by the matched pulse generator module 614 to obtain signal peaks representing the radial ranges of targets. In other words, the matched filtering module 613 is configured to process the cells arranged along the fast-time axis (the range domain DM_{R}). Additionally, the matched pulse generator module 614 not only can conjugate and flip the transmitted pulse, but also can compensate for radical responses of the receiver front-end channels. In a case where the detection distance range DDR[d] is scanned, the ideal pulse compression gain realized by the matched pulse generator module 614 can be represented as N_{S}^{P}[d]. The downsampling module 615 can adopt a suitable downsampling factor to maintain sufficient pulse compression gain while reducing the data volume in the fast-time domain.

The Doppler processing module 616 is configured to perform Doppler processing in the slow-time domain to measure the radial velocities of targets for given range bins, thereby outputting the set of data {D1} (also referred to as a set of Doppler processed data) which can be structured as the datacube DB. In addition, with the use of the chirp Z-transform module 617, several portions of the Doppler spectrum can be individually zoomed in to show spectral target peaks with adjustable resolution. Moreover, windowing techniques can be applied to the slow-time samples for sidelobe mitigation.

In the present embodiment, both the digital receiver circuit 628B and the digital receiver circuit 638B can employ pre-averaging, matched filtering, downsampling, and Doppler processing operations similar/identical to that employed by the digital receiver circuit 618B. For example, the digital receiver circuit 628B may include, but not limited to, a front-end channel compensation module 621, a pre-averaging module 622, a matched filtering module 623, a matched pulse generator module 624, a downsampling module 625, a Doppler processing module 626 and a chirp Z-transform module 627. The Doppler processing module 626 is configured to output the set of data {D2}, which can be structured as a datacube with a format similar/identical to that of the datacube DB. Similarly, the digital receiver circuit 638B may include, but not limited to, a front-end channel compensation module 631, a pre-averaging module 632, a matched filtering module 633, a matched pulse generator module 634, a downsampling module 635, a Doppler processing module 636 and a chirp Z-transform module 637. The Doppler processing module 636 is configured to output a set of data {D3}, which can be structured as a datacube with a format similar/identical to that of the datacube DB.

In some embodiments, the digital receiver circuit (or the signal processing circuit) may perform Doppler processing before matched filtering operation. For example, the positions of the matched filtering module 613 and the Doppler processing module 616 in the digital receiver circuit 618B can be swapped. As another example, the positions of the matched filtering module 633 and the Doppler processing module 636 in the digital receiver circuit 638B can be swapped. Associated modifications and alternatives fall within the scope of the present disclosure.

The digital receiver circuit 638B (or the signal processing circuit 330B shown in FIG. 3) can be further configured to apply beamforming to the datacube to generate angular information of a target. In the embodiment shown in FIG. 6, the digital receiver circuit 638B can utilize a horizontal beamforming module 640 to stack the datacubes provided by the subarrays 110 and 120 (the sets of data {D1} and {D2}) in the angular domain DRM (corresponding to a dimension of receiver arrangement or a spatial dimension), thereby forming a composite datacube (i.e. a combined set of data). In other words, the digital receiver circuit 638B can be configured to combine/merge the set of data {D1} and the set of data {D2} according to the arrangement of the antennas 112_1-112_m and 122_1-122_n along the first direction (the horizontal direction) shown in FIG. 1. The horizontal beamforming module 640 is configured to apply beamforming to the composite datacube (the combination of the sets of data {D1} and {D2}), thereby generating beamformed data DB1 which can contain azimuth spectrum information.

For example, the horizontal beamforming module 640 can utilize the chirp Z-transform (e.g. the chirp Z-transform module 617 implemented in the digital receiver circuit 638B) to present the effective portion of the azimuth spectrum (corresponding to a beam coverage of the current scanning operation) in higher resolution, thereby estimating the azimuth angle of the scanned target with accuracy that can be determined by the number of angle resolution bins. In a case where only one potential target resides in a range bin and a velocity bin, the azimuth angle corresponding to the maximum combining value (i.e. the highest signal peak in the effective portion of the azimuth spectrum) can be selected as the estimated azimuth angle.

In addition, the digital receiver circuit 638B can apply beamforming to the set of data {D3} with the use of a vertical beamforming module 642, thereby generating beamformed data DB2 which can contain elevation spectrum information. The vertical beamforming module 642 can utilize the chirp Z-transform (e.g. the chirp Z-transform module 617 implemented in the subarray 130) to present the effective portion of the elevation angle spectrum (corresponding to the fan beam coverage, such as between −60 degrees and +60 degrees) in higher resolution, thereby estimating the elevation angle of the scanned target to assess the height of the scanned target.

In the present embodiment, the digital receiver circuit 638B can generate the beamformed data DB1 according to the target elevation information. For example, referring to FIG. 6 and also to FIG. 1, in some cases where the spacings DH1 and DH2 are both equal to d_{A}, the spacing DH3 is equal to d_{LR}, and the signal wavelength is λ, the phase advances of the horizontal antennas (e.g. the antennas 112_1-112_m and 122_1-122_n shown in FIG. 1) obtained from the horizontal beamforming can be represented as 0,

$$2 π \frac{{d}_{A}}{λ} sin \overline{θ} ,$$

. . . ,

$$2 π ( m - 1 ) \frac{{d}_{A}}{λ} sin \overline{θ} ,$$

$$2 π ( m + \frac{{d}_{LR}}{{d}_{A}} - 1 ) \frac{{d}_{A}}{λ} sin \overline{θ} ,$$

$$2 π ( m + \frac{{d}_{LR}}{{d}_{A}} ) \frac{{d}_{A}}{λ} sin {\overline{θ}}^{} ,$$

. . . ,

$$2 π ( m + n + \frac{{d}_{LR}}{{d}_{A}} - 1 ) \frac{{d}_{A}}{λ} sin \overline{θ} ,$$

respectively, where

$$\frac{{d}_{A}}{λ}$$

is set to ½, and sin θ̅ represents sin θ cos ϕ for ease of calculation. Additionally, the phase advances of the vertical antennas (e.g. the antennas 132_1-132_p shown in FIG. 1) can be represented as 0,

$$2 π \frac{{d}_{A}}{λ} sin ϕ ,$$

. . . ,

$$2 π ( p - 1 ) \frac{{d}_{A}}{λ} sin ϕ ,$$

respectively. Thus, the digital receiver circuit 638B can rectify or correct the azimuth angles obtained from horizontal beamforming in terms of θ̅ based on the estimation results of elevations.

The digital receiver circuit 638B may further include a window coefficient generator module 644, which is configured to provide suitable/optimal window coefficients to reduce the maximum sidelobe peak in the angular spectrum (i.e. the azimuth/elevation spectrum) and/or Doppler spectrum. In some embodiments, the windowing operation can be integrated into the horizontal beamforming module 640 and/or the vertical beamforming module 642. In some embodiments, the windowing operation can be integrated into the Doppler processing modules 616/626/636.

The digital receiver circuit 638B (or the signal processing circuit 330B shown in FIG. 3) can be further configured to track and/or recognize targets according to the beamformed data DB1 and DB2. Referring again to FIG. 6 and FIG. 7, the digital receiver circuit 638B can be configured to apply beamforming to the cells of the datacube along the dimension of receiver arrangement (i.e. the angular domain DM_{A}) to thereby form a range-velocity plane. The digital receiver circuit 638B can be further configured to perform target detection according to the data on the range-velocity plane. Additionally, the digital receiver circuit 638B can be configured to determine a set of target candidates according to the data on the range-velocity plane and a set of thresholds, and determine a set of moving targets from the set of target candidates. An azimuth/elevation angle of each moving target in the set of moving targets falls within an azimuth/elevation coverage of the radar system (e.g. the radar system 100 shown in FIG. 1 or FIG. 3).

In the embodiment shown in FIG. 6, the digital receiver circuit 638B may further include, but is not limited to, an adaptive threshold detection module 646, an angle reasonability check module 648, a moving target indicator with clutter mapping module 650, a track filtering with data association module 652, and a target recognition module 654. With the use of the adaptive threshold detection module 646, the digital receiver circuit 638B can find out possible target signals above a threshold. For example, when a square magnitude of a complex value of a cell in the datacube (e.g. the set of data {D1}/{D2}) is larger than a corresponding threshold, it can be determined that a target may exist at a position of the cell. Note that the adaptive threshold detection module 646 can provide an individual threshold for each cell, and the individual threshold can be determined by statistics of cells adjacent to the cell.

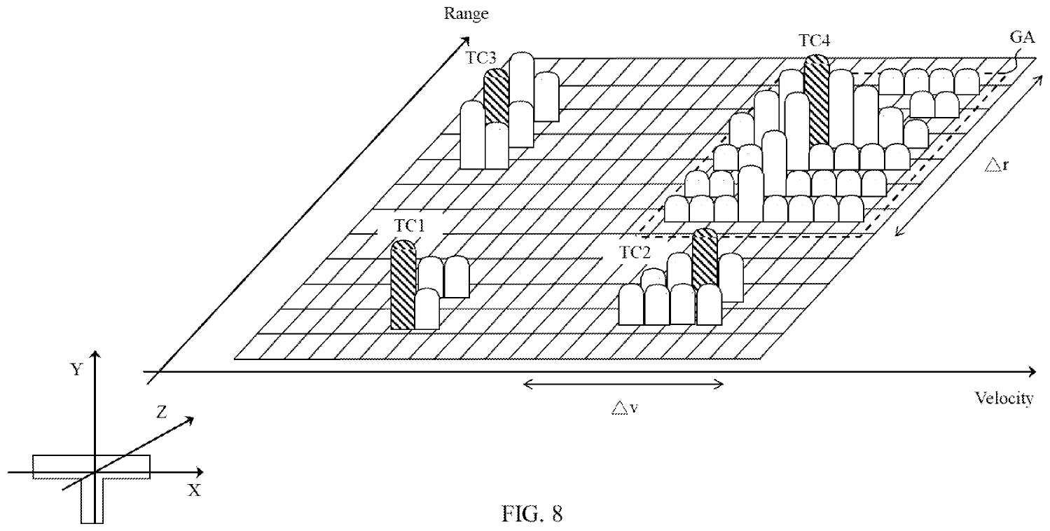

By way of example but not limitation, both the horizontal beamforming module 640 and the vertical beamforming module 642 can use the angular-max method to select an angle (i.e. an azimuth or elevation angle) corresponding to the highest signal peak in the effective portion of the angular spectrum, thereby forming a range-velocity plane. FIG. 8 is a diagram illustrating a range-velocity plane outputted by the horizontal beamforming module 640 shown in FIG. 6 (or the vertical beamforming module 642) in accordance with some embodiments of the present disclosure. Referring to FIG. 8 and also to FIG. 6, the adaptive threshold detection module 646 can pick out target candidates TC1-TC4 (filled with diagonal lines) and remove noise components (blank parts around the target candidates TC1-TC4). Additionally, in the example shown in FIG. 8, the adaptive threshold detection module 646 can firstly group the data on the range-velocity plane according to a predetermined mainlobe width (e.g. a certain proportion of a theoretical mainlobe width). For example, one of data groups is the group GA indicated by a dashed box, and the grouping area of the group GA is specified by Δr and Δv. Next, the adaptive threshold detection module 646 can select a cell, having a complex value with the maximum square magnitude in the group GA, as the target candidate TC4.

Next, the angle reasonability check module 648 can check if each target candidate in the selected set of target candidates has reasonable azimuth and elevation angles. For example, the angle reasonability check module 648 can check if the azimuth and elevation angles of each target candidate are within the azimuth and elevation coverages of the radar system, respectively. When the azimuth angle of a target candidate is outside the azimuth coverage, or the elevation angle of the target candidate is outside the elevation coverage, the angle reasonability check module 648 can delete the target candidate from the set of target candidates. As another example, in some cases where the spacing between adjacent antennas is half of a beam wavelength, the angle reasonability check module 648 can determine whether a target candidate satisfies both of the following criteria:

$$\vert \frac{λ}{{d}_{A}} \frac{sin ϕ}{2} \vert \leq 1 and \vert \frac{λ}{{d}_{A}} \frac{sin \overline{θ}}{2 cos ϕ} \vert \leq 1.$$

When it is determined that the target candidate does not meet both criteria, the angle reasonability check module 648 can delete the target candidate from the set of target candidates.

In some embodiments, the horizontal beamforming module 640 and/or the vertical beamforming module 642 may employ other beamforming methods to reduce the data volume of the datacube. For example, the horizontal beamforming module 640 (or the vertical beamforming module 642) can select a plurality of angles corresponding to higher signal peaks in the effective portion of the angular spectrum to reduce the data volume of the datacube. The adaptive threshold detection module 646 can determine a set of cells, from the datacube with reduced data volume outputted by the horizontal beamforming module 640 (or the vertical beamforming module 642), to be used as a set of target candidates according to a set of thresholds. The angle reasonability check module 648 can check if the azimuth and elevation angles of each target candidate in this set of target candidates are reasonable.

Furthermore, the moving target indicator with clutter mapping module 650 can determine whether a target candidate is a moving target or a clutter return according to the RCS of the target candidate. For example, the main characteristics of the surface clutter, such as ground or buildings, are stationary and larger RCS; the sea clutter possesses randomly slow motion and diverse levels. In some embodiments, the estimated ranges, azimuths, elevations, velocities, and RCSs of the target candidates may have already been collected as a target information list. The RCSs can be derived according to the range information and SNR requirements. The moving target indicator with clutter mapping module 650 can distinguish between moving targets and clutter returns according to the target information list, that can be obtained from the current and previous scans by analyzing the motion states in the three-dimensional space and examining the reasonability of the RCS.

With the use of the data association mechanisms, the track filtering with data association module 652 can adaptively estimate and predict the trajectories of targets, smoothly track multiple targets (e.g. unmanned aerial vehicles (UAVs) or drones), and exclude clutter and jammers that are falsely identified as targets. The target recognition module 654 can utilize micro-Doppler signatures to classify targets (e.g. target(s) located within the target recognition region TRR shown in FIG. 4), and/or recognize targets according to behavioral evaluation criteria. For example, when it is determined that a target is rapidly approaching the radar system with a straight track, the target recognition module 654 can identify this target as an urgent threat. In addition, the outputs of the track filtering with data association module 652 and the target recognition module 654 can serve as the resulting target information.

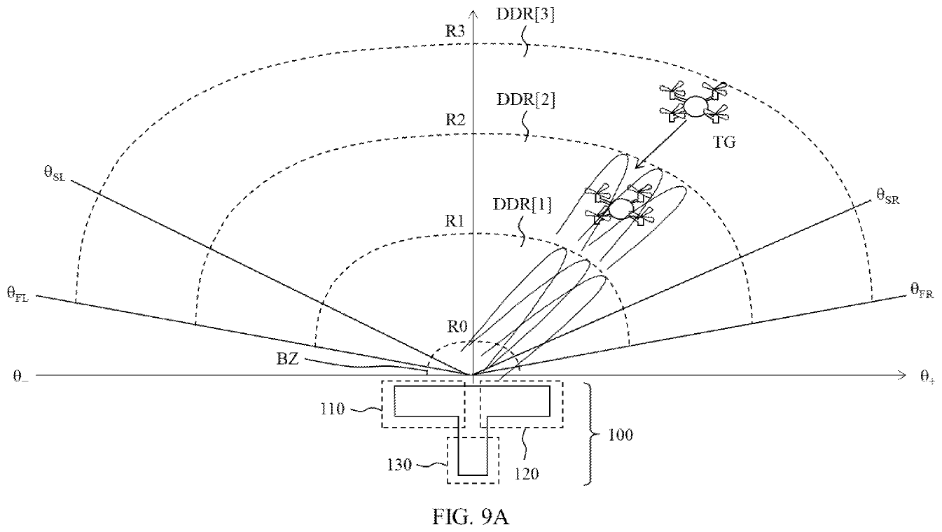

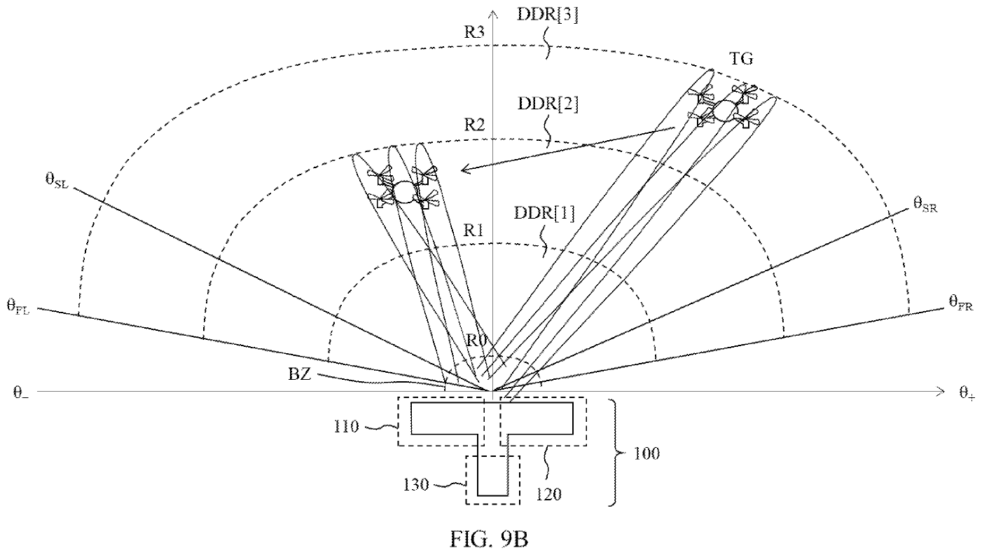

Note that the signal and data processing scheme described above can be applied to other scanning modes of the radar system. FIG. 9A is a diagram illustrating operation of the radar system 100 shown in FIG. 1 in a scanning mode in accordance with some embodiments of the present disclosure. In the scanning mode shown in FIG. 9A, the subarrays 110 and 120 can narrow the scanning volume according to the approaching direction of the target TG. The signal and data processing scheme described above can be applied to the scanning mode shown in FIG. 9A, thereby facilitating the radar system 100 to monitor (or fire on) the target TG with a higher target track update rate.

FIG. 9B is a diagram illustrating operation of the radar system 100 shown in FIG. 1 in another scanning mode in accordance with some embodiments of the present disclosure. In the scanning mode shown in FIG. 9B, the radar system 100 can predict the next localization or position of the target TG according to the current and previous target detection results, and emit beams to the predicted position. The signal and data processing scheme described above can be applied to the scanning mode shown in FIG. 9B so that the radar system 100 can predict the potential movement path of the target TG in the future. In some embodiments, the scanning modes shown in FIG. 4, FIG. 9A and FIG. 9B may utilize the same signal formats with differences in scheduling beams. In some embodiments, users may select a scanning mode and/or track a target of interest via the user interface 140 shown in FIG. 2.

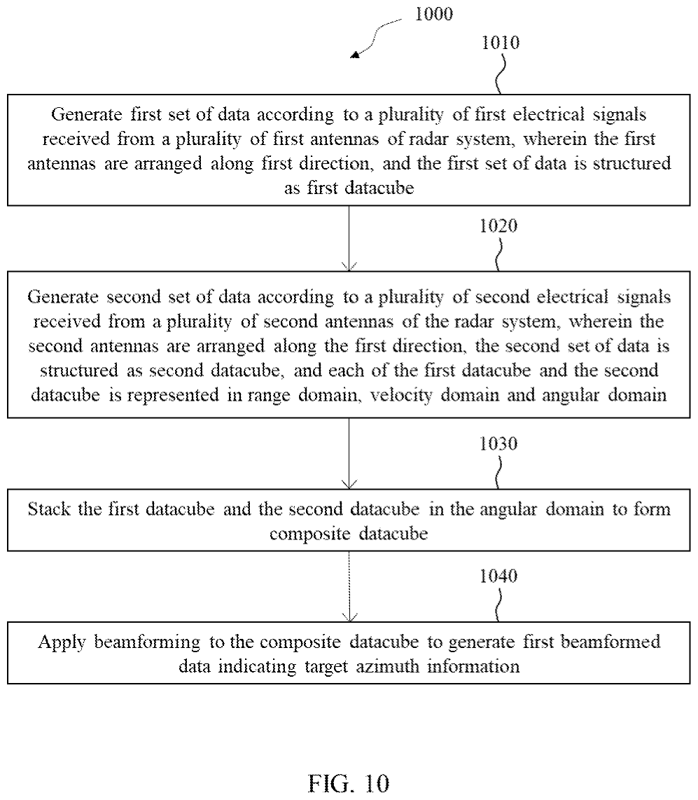

FIG. 10 is a flow chart of a data processing method for a radar system in accordance with some embodiments of the present disclosure. For illustrative purposes, the data processing method 1000 is described with reference to the radar system 100 shown in FIG. 3. Note that the data processing method 1000 can be applied to the radar system 100 shown in FIG. 1, the DSDP block shown in FIG. 6, and other radar systems utilizing two-dimensional sparse orthogonal linear phased arrays and related DSDP blocks without departing from the scope of the present disclosure. Additionally, in some embodiments, other operations/steps can be performed in the data processing method 1000. In some embodiments, operations/steps of the data processing method 1000 may be performed in a different order and/or vary.

Referring to FIG. 10 and also to FIG. 3, in step 1010, a first set of data is generated according to a plurality of first electrical signals received from a plurality of first antennas of the radar system. The first antennas are arranged along a first direction, and the first set of data is structured as a first datacube. For example, the signal processing circuit 310B can generate the set of data {D1} according to the electrical signals S_{RI1_1}-S_{RI1_m} received from the antennas 112_1-112_m, and the set of data {D1} can be structured as a datacube that can be similar in structure to the datacube DB shown in FIG. 7.

In step 1020, a second set of data is generated according to a plurality of second signals received from a plurality of second antennas of the radar system. The second antennas are arranged along the first direction, and the second set of data is structured as a second datacube. Each of the first of datacube and the second datacube is represented in a range domain, a velocity domain and an angular domain. For example, the signal processing circuit 320B can generate the set of data {D2} according to the electrical signals S_{RI2_1}-S_{RI2_n} received from the antennas 122_1-122_n, and the set of data {D2} can be structured as a datacube that can be similar in structure to the datacube DB shown in FIG. 7.

In step 1030, the first datacube and the second datacube are stacked in the angular domain to form a composite datacube. For example, the signal processing circuit 330B (or the digital receiver circuit 338B) may stack the set of data {D1} and the set of data {D2} in the angular domain DM_{A} to form a combined datacube that can be similar in structure to the datacube DB shown in FIG. 7.

In step 1040, beamforming is applied to the composite datacube to generate first beamformed data indicating target azimuth information. For example, the signal processing circuit 330B (or the digital receiver circuit 338B) may apply beamforming to the composite datacube (combined from the sets of data {D1} and {D2}) to generate beamformed data (e.g. the beamformed data DB1 shown in FIG. 6).

In some embodiments, in step 1040, the signal processing circuit 330B (or the digital receiver circuit 338B) may apply beamforming to cells of the composite datacube in the angular domain DM_{A} to form a range-velocity plane (e.g. the range-velocity plane shown in FIG. 8). The first beamformed data generated in step 1040 can be represented as the range-velocity plane. Additionally or alternatively, the signal processing circuit 330B (or the digital receiver circuit 338B) may determine a set of target candidates (e.g. the target candidates TC1-TC4 shown in FIG. 8) according to the data on the range-velocity plane and a set of thresholds, and determine a set of moving targets from the set of target candidates. An azimuth angle of each moving target falls within an azimuth coverage of the radar system 100.

In some embodiments, the signal processing circuit 330B (or the digital receiver circuit 338B) may generate the set of data {D3} according to the electrical signals S_{RI3_1}-S_{RI3_p} received from the antennas 132_1-132_p, and may apply beamforming to the set of data {D3} to generate beamformed data indicating target elevation information (e.g. the beamformed data DB2 shown in FIG. 6).

As those skilled in the art can appreciate the operation of the data processing method 1000 after reading above paragraphs directed to FIG. 1 to FIG. 9B, further description is omitted here for brevity.

The proposed radar system can utilize a two-dimensional sparse orthogonal linear phased array to perform target detection and positioning in a three-dimensional space, thereby significantly reducing manufacturing costs and effectively detecting targets with small radar cross-sections, low flying speeds and altitudes, and/or arbitrary trajectories. In addition, the proposed radar signal and data processing scheme not only can reduce the complexity of signal processing and the amount of transmitted data, but also can generate highly accurate target information.

The foregoing outlines features of several embodiments so that those skilled in the art may better understand the aspects of the present disclosure. Those skilled in the art should appreciate that they may readily use the present disclosure as a basis for designing or modifying other processes and structures for carrying out the same purposes and/or achieving the same advantages of the embodiments introduced herein. Those skilled in the art should also realize that such equivalent constructions do not depart from the spirit and scope of the present disclosure, and that they may make various changes, substitutions, and alterations herein without departing from the spirit and scope of the present disclosure.

What is claimed is:

1. A radar system, comprising:
a first subarray comprising a plurality of first antennas arranged along a first direction;
a second subarray comprising a plurality of second antennas arranged along the first direction; and
a third subarray comprising a plurality of third antennas arranged along a second direction orthogonal to the first direction, the third subarray being configured to combine a first set of data received from the first subarray and a second set of data received from the second subarray into a combined set of data, generate first beamformed data indicating target azimuth information by applying beamforming to the combined set of data, and generate second beamformed data indicating target elevation information according to a plurality of input signals received by the third antennas.

2. The radar system of claim 1, wherein the third subarray is configured to combine the first set of data and the second set of data according to an arrangement of the first antennas and the second antennas along the first direction.

3. The radar system of claim 1, wherein the third antennas are configured to generate a plurality of electrical signals according to the input signals; the third subarray further comprises:
a signal processing circuit, coupled to the first subarray, the second subarray and the third antennas, the signal processing circuit being configured to apply beamforming to the combined set of data to generate the first beamformed data, process the electrical signals to generate a third set of data, and apply beamforming to the third set of data to generate the second beamformed data.

4. The radar system of claim 3, wherein the signal processing circuit is configured to generate the first beamformed data according to the target elevation information.

5. The radar system of claim 3, wherein the combined set of data is structured as a datacube represented in a range domain, a velocity domain and an angular domain; the signal processing circuit is configured to apply beamforming to cells of the datacube in the angular domain to form a range-velocity plane, and perform target detection according to data on the range-velocity plane.

6. The radar system of claim 5, wherein the signal processing circuit is configured to determine a set of target candidates according to the data on the range-velocity plane and a set of thresholds, and determine a set of moving targets from the set of target candidates; an azimuth angle of each moving target falls within an azimuth coverage of the radar system.

7. The radar system of claim 3, wherein the signal processing circuit is configured to perform matched filtering and Doppler processing upon the electrical signals to generate the third set of data.

8. The radar system of claim 1, wherein the combined set of data is a set of Doppler processed data.

9. The radar system of claim 1, wherein the first subarray further comprises:
a signal processing circuit, coupled to the first antennas, the signal processing circuit being configured to receive a plurality of electrical signals from the first antennas, and perform matched filtering and Doppler processing upon the electrical signals to generate the first set of data.

10. The radar system of claim 1, wherein the first subarray is formed on a first circuit board, the second subarray is formed on a second circuit board separated from the first circuit board, and the third subarray is formed on a third circuit board electrically connected to each of the first circuit board and the second circuit board.

11. A radar system, comprising:
a first subarray comprising:
a plurality of first antennas arranged along a first direction; and
a first signal processing circuit, coupled to the first antennas, the first signal processing circuit being configured to process a plurality of first electrical signals received from the first antennas to generate a first set of data;
a second subarray comprising:
a plurality of second antennas arranged along the first direction; and
a second signal processing circuit, coupled to the second antennas, the second signal processing circuit being configured to process a plurality of second electrical signals received from the second antennas to generate a second set of data; and
a third subarray comprising:
a plurality of third antennas arranged along a second direction orthogonal to the first direction; and
a third signal processing circuit, coupled to the first signal processing circuit, the second signal processing circuit and the third antennas, the third signal processing circuit being configured to generate first beamformed data indicating target azimuth information according to the first set of data and the second set of data.

12. The radar system of claim 11, wherein the third signal processing circuit is configured to combine the first set of data and the second set of data into a combined set of data, and apply beamforming to the combined set of data to generate the first beamformed data.

13. The radar system of claim 12, wherein the first set of data is structured as a first datacube, the second set of data is structured as a second datacube, and each of the first datacube and the second datacube is represented in a range domain, a velocity domain and an angular domain; the third signal processing circuit is configured to stack the first datacube and the second datacube in the angular domain to form a composite datacube serving as the combined set of data.

14. The radar system of claim 11, wherein each of the first set of data and the second set of data is a set of Doppler processed data.

15. The radar system of claim 11, wherein the third signal processing circuit is further configured to process a plurality of third electrical signals received from the third antennas to generate a third set of data, and generate second beamformed data indicating target elevation information according to the third set of data.

16. The radar system of claim 11, wherein the first signal processing circuit is formed on a first circuit board, the second signal processing circuit is formed on a second circuit board separated from the first circuit board, and the third signal processing circuit is formed on a third circuit board electrically connected to each of the first circuit board and the second circuit board.

17. A data processing method for a radar system, comprising:
generating a first set of data according to a plurality of first electrical signals received from a plurality of first antennas of the radar system, wherein the first antennas are arranged along a first direction, and the first set of data is structured as a first datacube;
generating a second set of data according to a plurality of second electrical signals received from a plurality of second antennas of the radar system, wherein the second antennas are arranged along the first direction, the second set of data is structured as a second datacube, and each of the first datacube and the second datacube is represented in a range domain, a velocity domain and an angular domain;
stacking the first datacube and the second datacube in the angular domain to form a composite datacube; and
applying beamforming to the composite datacube to generate first beamformed data indicating target azimuth information.

18. The data processing method of claim 17, wherein the step of apply beamforming to the composite datacube to generate the first beamformed data comprises:
applying beamforming to cells of the composite datacube in the angular domain to form a range-velocity plane, wherein the first beamformed data is represented as the range-velocity plane.

19. The data processing method of claim 18, further comprising:
determining a set of target candidates according to data on the range-velocity plane and a set of thresholds; and
determining a set of moving targets from the set of target candidates, wherein an azimuth angle of each moving target falls within an azimuth coverage of the radar system.

20. The data processing method of claim 17, further comprising:
generating a third set of data according to a plurality of third electrical signals received from a plurality of third antennas of the radar system, wherein the third antennas are arranged along a second direction orthogonal to the first direction; and
applying beamforming to the third set of data to generate second beamformed data indicating target elevation information.
